(19) United States
(12) Patent Application Publication
(10) Pub. No.: US 2012/0099194 A1
(43) Pub. Date: Apr. 26, 2012

(54) MULTI-VIEW DEVICE FOR GENERATING ANIMATIONS OR THREE DIMENSIONAL IMAGES

(75) Inventor: Coen Adrianus Verschuren, Eindhoven (NL)

(73) Assignee: KONINKLIJKE PHILIPS ELECTRONICS N.V., EINDHOVEN (NL)

(21) Appl. No.: 13/379,049

(22) PCT Filed: Jun. 14, 2010
(86) PCT No.: PCT/IB2010/052635

§ 371 Date: Dec. 19, 2011

(30) Foreign Application Priority Data
Jun. 19, 2009 (EP) 09163188.7

(51) Int. Cl. G02B 27/22; F21V 13/04; F21V 5/00

(52) U.S. Cl. 359/463; 362/311.02; 362/309

(57) ABSTRACT

The invention relates to a multi-view device (100) for generating a first image at a first viewing angle (211) and for generating a second image at a second viewing angle (221) different from the first viewing angle (211). The multi-view device (100) comprises a composite image, an array of elongated optical structures (101) and an Organic Light Emitting Diode device (103). The composite image comprising elongated stripes of sub images (210, 220) comprising the first image and the second image. The array of elongated optical structures (101) is for refracting light (212) of the first image into the first viewing angle (211), and for refracting light (222) of the second image into the second viewing angle (221). The Organic Light Emitting Diode device (103) is for imaging the composite image via the array of elongated optical structures (103). The Organic Light Emitting Diode device (103) is optically coupled to the array of elongated optical structures (103). Using an Organic Light Emitting Diode device (103) which is optically coupled to the array of elongated optical structures (101), the multi-view device (100) is light efficient.

### FIELD OF THE INVENTION

The invention relates to a multi-view device for generating different images to a viewer in different directions and relates to an assembly comprising the multi-view device.

### BACKGROUND OF THE INVENTION

Multi-view devices are well-known in the art. For example, in the form of greeting cards presenting a three dimensional image or displays that image a three dimensional movie. To obtain an auto stereoscopic effect two images are provided at two viewing directions in order to image two slightly different images in the eyes of a person such that the person experiences a three dimensional picture. In other applications more than two images are provided at a plurality of viewing angles. If a person or, for example, a camera moves relative to the multi-view device, different images will be seen. The images may be subsequent images of a film scene and the person will see this short film scene. The short series of images may also be an animation, or a specific type of animation like for example a comic, a morph or a zoom.

Published patent specification U.S. Pat. No. 5,695,346 discloses several embodiments of multi-view devices which present an auto stereoscopic image to a user or presents an animation. One of the devices described in the cited patent specification is a shelf header slide-in display assembly. The shelf header slide-in assembly consists of a translucent basis on which two dimensional translucent images and a special interlaced translucent image are printed. An array of lenticular lenses is provided in front of the interlaced image. The shelf header slide-in assembly is back lit with a light source.

The interlaced image consists of alternating stripes of two or more images. If back lit, the surface of the shelf header slide-in assembly emits light into the direction of a visitor of the shop. If not back lit, a part of the ambient light is reflected. At the area of the interlaced image the emitted and reflected light is refracted by the array of lenticular lenses such that light originating from the stripes of one image is refracted into one specific viewing direction, and light originating from the stripes of another image is refracted into another specific viewing direction.

The interlaced image and the array of lenticular lenses is designed such that a visitor of the shop who stands in front of the shelf and who looks towards the shelf header experiences a three dimensional image at the position of the interlaced image. Alternatively, the shelf header slide-in assembly may be designed such that, if the visitor passes along the shelf and looks towards the shelf header, the visitor sees an animation, representing a series of successive images.

A problem of the disclosed shelf header slide-in assembly is that the assembly is not light efficient.

### SUMMARY OF THE INVENTION

It is an object of the invention to provide a more efficient multi-view device.

A first aspect of the invention provides a multi-view device as claimed in claim 1. Advantageous embodiments are defined in the dependent claims.

A multi-view device in accordance with the first aspect of the invention comprises a composite image, an array of elongated optical structures, and an Organic Light Emitting Diode device. The composite image comprises elongated stripes of sub images. The elongated stripes of sub images comprise a first image and a second image. Light from the Organic Light Emitting Diode device images the composite image. The array of elongated optical structures refracts light of the first image into a first viewing angle and refracts light of the second image into a second viewing angle. The Organic Light Emitting Diode device is optically coupled to the array of elongated optical structures. The multi-view device generates, provides, or presents the first image into the first viewing angle and generates, provides, or presents the second image into the second viewing angle.

Optical coupling between the Organic Light Emitting Diode and the array of elongated optical structures means that light can freely travel from the Organic Light Emitting Diode device to the array of elongated optical structures without capturing a substantial part in one of the layers of, for example, the Organic Light Emitting Diode device. The Organic Light Emitting Diode device is typically manufactured on a substrate which is for example a layer of glass or a sheet which is transparent or translucent. The substrate has a specific refractive index and a further optical medium positioned adjacent to the substrate has another specific refractive index. If the refractive index difference between the refractive index of the substrate and the refractive index of the another optical medium is significantly large, light may be captured and confined in the substrate via well known total internal refraction (also known as TIR). Confinement of light when using Organic Light Emitting Diode devices is important because Organic Light Emitting Diodes emit light in a substantially Lambertian distribution. When the refractive index difference is relatively large, e.g. when the other optical medium adjacent to the substrate is air, a significant part of the light generated by the Lambertian distribution strikes the interface between the substrate and air at an angle larger a critical angle, thus being reflected back into the substrate and being confined in the substrate. This confined light does not contribute to the generation of the first and the second image. Two adjacent optical media are optically coupled if the absolute refractive index difference between the refractive indices of the two optical media is relatively small, for example the absolute refractive indices difference is smaller than 0.1. In such an arrangement substantially all light may freely travel between the two adjacent optical media.

When the Organic Light Emitting Diode device and the array of elongated optical structures are optically coupled, the light emitted by the light emitting layer of the Organic Light Emitting Diode is substantially not captured by the substrate of the Organic Light Emitting Diode device alone or by any other optical medium between the Organic Light Emitting Diode device and the array of elongated optical structures. Hence, substantially all light emitted by the Organic Light Emitting Diode travels freely to the array of elongated optical structures. It should be noted that an air gap between the Organic Light Emitting Diode device and the array of elongated optical structures cannot be regarded as an optical coupling between the Organic Light Emitting Diode device and the array of elongated optical structures because the refractive index difference between the refractive indices of the media of the Organic Light Emitting Diode device and the refractive index of air is too large.

Due to the optical coupling between the Organic Light Emitting Diode device and the array of elongated optical structures, the array of elongated optical structures does not only refract light of different images in different viewing direction, but also reduces the capturing of light in the multi-view device. The array of elongated optical structures comprises a surface with varying angles forming the elongated optical structures. The surface with varying angles reduces the amount of internal reflections at the boundary interface of the array of elongated optical structures and the ambient. This result in the effect that more light of the Organic Light Emitting Diode device is able to travel to the ambient of the multi-view device and less light is captured in the multi-view device. Thus, efficiency is improved.

The energy efficiency of the multi-view device is increased in relation to the known multi-view devices by using Organic Light Emitting Diode light source, which is a very efficient light source, and by the optical coupling between the Organic Light Emitting Diode device and the array of elongated optical structures.

It should be noted that the array of elongated optical structures has two functions. The first function is refracting the light of the first image into a first viewing direction and refracting the light of the second image into the second viewing direction. The second function is reducing the confinement of light in the multi-view device and as such a better transmission of light from the Organic Light Emitting Diode device towards the ambient of the multi-view device.

An additional advantage of the multi-view device is that it is relatively thin because of the use of an Organic Light Emitting Diode device, which is a relatively thin light source. Because of its compact design the multi-view device may be arranged on the cover of a book, or as an integral part of a greeting card or business card. Furthermore, an energy supply to the multi-view device is not a problem because the multi-view device is efficient and only requires a small battery.

The multi-view device according to the first aspect of the invention may be used in several applications. An apparatus may be provided with 3d push buttons that comprise the multi-view device on top of the push button. In another application high value company logos are presented in an exhibition boot or, for example, presenting an animated company logo in a shelf, or shelf header, of a store.

In an embodiment, the Organic Light Emitting Diode device comprises a patterned Organic Light Emitting Diode. At least a part of the composite image is patterned in the patterned Organic Light Emitting Diode. With a patterning technique at least a part of the composite image may be patterned in the Organic Light Emitting Diode. In this embodiment the imaging of at least a part of the composite image by the Organic Light Emitting Diode is performed by generating, or creating, the at least a part of the composite image in the Organic Light Emitting Diode device. The patterning of the patterned Organic Light Emitting Diode is done by changing locally the characteristics of one or more layers of the patterned Organic Light Emitting Diode. This may be done e.g. by generating scratches in a substrate or a light reflective layer of the Organic Light Emitting Diode. Other embodiments of patterning are for example locally destructing a layer with organic light emitting material or by the local ablation of the material of a layer of the Organic Light Emitting Diode.

The patterning does not result in a loss of efficiency of the Organic Light Emitting Diode light source, because the patterning is performed such that no light is emitted at the position where, for example, a black pixel is patterned, or because the patterning is performed such that light created at the position of a black pixel is scattered into a direction of a position where no black pixel is patterned. Thus, either the light is not created and not emitted, or the light is created but emitted to the ambient at another position. Hence, no light is absorbed or lost.

In a further embodiment, at least a part of the composite image is patterned in a current support layer of the patterned Organic Light Emitting Diode device. Alternatively, at least a part of the composite image is patterned in a light-reflective layer of the Organic Light Emitting Diode device. In this embodiment the imaging of at least a part of the composite image by the Organic Light Emitting Diode is performed by generating, or creating, the image in the light reflective layer of Organic Light Emitting Diode device or in the current support layer of the Organic Light Emitting Diode device.

A first unpublished patent application of the applicant with attorney docket number PH011821EP1 discloses a patterned Light Emitting Diode device, a method of generating a patterning, a system for patterning and a method of calibrating the system. The patterned light emitting diode device of the first unpublished patent application comprises a layer of light emitting material and comprises a light-reflective layer being visible through a light-emission window of the patterned light emitting diode device. The light-reflective layer comprises a pattern constituted of local deformations of the light-reflective layer which comprises the at least part of the composite image.

A patterned Organic Light Emitting Diode wherein the part of the composite image is patterned in the light-reflective layer shows the composite image when the Organic Light Emitting Diode device is in the on-state as well as in the off-state. In the on-state the Organic Light Emitting Diode device emits light, in other words, the Organic Light Emitting Diode is in operation. In the off-state the Organic Light Emitting diode does not emit light and is not in operation. For specific applications it may be advantageous to have the part of the composite image visible under all operating conditions. For example, under daylight conditions the Organic Light Emitting Diode device may be switched off, while at the same time the part of the composite image is visible. This saves energy. During the night the Organic Light Emitting Diode device may be switched on such that the part of the composite image is also visible in the dark. Furthermore, the light-reflective layer is patterned such that it scatters the light locally differently compared to the non-patterned part of the light-reflective layer. The light that is scattered differently is still emitted towards the user, only not at the positions of the pattern. The light may be scattered at such angles that it may be subject to total internal refraction (TIR). If the Organic Light Emitting Diode device is optically coupled to the array of elongated optical structures, the scattered light will not be captured in the substrate of the Organic Light Emitting Diode device. Thus, not much light is lost, which is especially advantageous if the Organic Light Emitting Diode device is in operation. If the Organic Light Emitting Diode device is in the on-state, the scattered light increases the brightness of the multi-view device and as such the multi-view device is energy efficient in operation.

The first unpublished patent application discloses a method and a system of patterning as well. The patterning is performed with a condensed light beam, for example of a laser, and the patterning may be performed after the manufacturing of the Organic Light Emitting Diode device. It may even be performed after or during the manufacturing of the multi-view device. This allows a high flexibility regarding which specific first image and which specific second image is used in the composite image. In other words, the multi-view device may be customized relatively easily on request and it is not required to manufacture a large number of multi-view devices in order to obtain an inexpensive multi-view device. A high resolution may be obtained by patterning with a condensed light beam. The smallest size of the pixels is in the range of a few micro meters. This results in a better user experience because of a higher resolution.

A second unpublished patent application of the applicant with attorney docket number PH010977EP1 discloses a patterned Organic Light Emitting Diode device, a method of generating a patterning, a system for patterning and a method of calibrating the system. The patterned Organic Light Emitting Diode device according to the second unpublished patent application comprises organic light emitting material arranged between an anode layer and a cathode layer, the Organic Light Emitting Diode device further comprises at least one current support layer for enabling, assisting and/or dimensioning a current flowing, in operation, through the light emitting material to cause the light emitting material to emit light, the current support layer not being the anode layer, cathode layer nor the organic light emitting material. At least a part of the at least one current support layer being patterned by locally altering a current support characteristic of the at least one current supporting layer while substantially not altering the organic light emitting material, the anode layer nor the cathode layer. The current support characteristic locally determines the current flowing through the organic light emitting material in operation.

A patterned Organic Light Emitting Diode wherein a part of the composite image is patterned in one of the current support layers is energy efficient because the flow of electrons is locally influenced such that no light is generated at the position of a black pixel, or less light is created at a pixel with a certain grey level. Typically the pattern is only visible in the on-state and not in the off-state of the Organic Light Emitting Diode. Therefore, by switching between the on-state and the off-state a multi-view device that selectively shows the part of the image or shows not the part of the image may be created. The patterning of the patterned Organic Light Emitting Diode of the second unpublished pattern application may be generated by a condensed light beam, for example via laser irradiation, which may be done after the manufacturing of the Organic Light Emitting Diode device. Thus, it allows also a high flexibility regarding the moment at which the Organic Light Emitting Diode is patterned and regarding the content of the part of the composite image that is patterned.

It should be noted that in this specific embodiment, in which at least a part of the composite image is patterned in a current support layer or a light-reflective layer of the patterned Organic Light Emitting Diode device, it is not an essential feature that the Organic Light Emitting Diode device and the array of elongated optical structures are optically coupled for generating a three dimensional or animate image. For example, an air gap may be arranged between the Organic Light Emitting Diode device and the array of elongated optical structures. Without the optical coupling as previously defined these current embodiment are already an alternative for providing a three dimensional or animated image.

In another embodiment, the Organic Light Emitting Diode device is constituted by a single one-pixel Organic Light Emitting Diode. Organic Light Emitting Diodes may be manufactured as a single light source constituted by an uninterrupted stack of layers which emits light in operation. Such an Organic Light Emitting Diodes is relatively thin compared to the area of the light emitting surface and has only one cathode and one anode and requires, as such, only two power wires. Using the one-pixel Organic Light Emitting Diode in the multi-view device results in a less complex hardware configuration compared to device in which more than a single one pixel light sources are used. For example, there is no need to additional wires to the second pixel. Furthermore, plural pixel light sources have in general a small non-light emitting border between the pixels, while the one pixel Organic Light Emitting Diode has a large area with a uniform light emission.

In a further embodiment, the Organic Light Emitting Diode device of the multi-view device comprises a substrate. The substrate is for supporting an anode layer, a cathode layer and/or organic light emitting layers of the Organic Light Emitting Diode. Light of the Organic Light Emitting Diode is typically emitted through the substrate. The side of the substrate facing away from the Organic Light Emitting Diode comprises the array of elongated optical structures for refracting light from the first image into a first viewing angle and refracting light from the second image into a second viewing angle. The array of elongated optical structures may, for example, be etched in the substrate if the substrate is of glass. It is beneficial to use the substrate not only for manufacturing the Organic Light Emitting Diode on the substrate, but also for the array of elongated optical structures, because it results in an optimal optical coupling between the Organic Light Emitting Diode and the array of elongated optical structures. Moreover, the multi-view device of this further embodiment requires fewer components which is beneficial regarding the manufacturing process and manufacturing costs. It is possible to create a single element multi-view device if at least a part of the composite image is patterned in the Organic Light Emitting Diode and the substrate comprises the array of elongated optical structures.

In an embodiment, the multi-view device comprises an optical sheet. The optical sheet comprises the array of elongated optical structures and the optical sheet is optically coupled to the Organic Light Emitting Diode device. An optical sheet is cheap and easy to manufacture. For example, a thermal roll with protrusions related to the shape of the optical structure may be rolled over the sheet in order to obtain the array of optical structures. Additionally, it is easy to adhere the optical sheet to the Organic Light Emitting Diode device, for example by transparent glue that ensures good optical coupling between the optical sheet and the Organic Light Emitting Diode device. Another technique of manufacturing an optical sheet as part of the multi-view device is by creating a layer on top of the substrate of the Organic Light Emitting Diode device by a spin coating technique, and using an imprint technique to create the elongated optical structures in this layer.

In a further embodiment, the multi-view device comprises at least a partially translucent film. At least a part of the composite image is provided on the partially translucent film. The partially translucent film is arranged between the Organic Light Emitting Diode device and the array of elongated optical structures. In this embodiment the imaging of at least a part of the composite image by the Organic Light Emitting Diode device is performed by illuminating the at least part of composite image, which is arranged between the Organic Light Emitting Diode device and the array of elongated optical structures. Providing a part of the composite image on a partially translucent film is relative simple, for example by known printing techniques. Moreover, the current embodiment allows a flexible customization because providing the part of the composite image by a printing technique allows the printing of individually designed composite images. Additionally, the part of the composite image on the partially translucent film may be a color image, which enables three dimensional color imaging applications.

The translucent film is arranged between the Organic Light Emitting Diode device and the array of elongated optical structures. At locations where the part of the composite image is provided on the translucent film the characteristics of the emitted light are influenced, for example, the intensity is reduced or part of the light is absorbed to change the color. Additionally another part of, or the same part of, the composite image may be patterned in the Organic Light Emitting Diode device. This is beneficial, for example, for creating complete black pixels. The Organic Light Emitting Diode device may be patterned such that no light is emitted at the position of the black pixels. Thus, the part of the image patterned in the Organic Light Emitting Diode device may be used to increase the contrast of the images seen by the user at the different viewing angles and results in additional energy efficiency. Instead of absorbing light in the translucent film at darker areas of the part of the composite image, less light is created at the darker areas of the image and as such less light is absorbed in the darker areas.

It should be noted that at least partially translucent is defined by at least letting light passing through the sheet. In the embodiment the at least partially translucent sheet allows at least a part of the light generated by the Organic Light Emitting Diode device to travel towards the array of elongated optical structured. Hence, a partially translucent sheet may comprise a partially transparent sheet and/or a diffusing sheet.

In a further embodiment, the array of elongated optical structures comprises lenticular lenses and/or the array of elongated optical structures comprises elongated triangular prisms. Lenticular lenses and rectangular prisms are well suitable for refracting the light of the different images of the composite images into different viewing angles.

It should be noted that the array of elongated optical structures is not limited to embodiments of lenticular lenses and/or triangular prisms. Optical structures capable of refracting the light of a first image into a first viewing angle and refracting the light of a second image into a second viewing direction may be used in the invention as well.

In a further embodiment, the composite image together with the array of elongated optical structures of the multi-view device are configured to generate an auto stereoscopic image to a user who is looking towards the multi-view device. The user experiences a three-dimensional image.

In another embodiment, the composite image together with the array of elongated optical structures of the multi-view device are configured to generate a series of images to a viewer who is looking towards the multi-view device and who moves relative to the multi-view device. If a series of images is integrated in the composite images and if they are generated at different viewing angles, the user has to move relative to the multi-view device in order to see the series of images at the different viewing angles. If the series of images form a series of interconnected successive images the user experiences an animation. The animation may be a short film scene, a morph or a zoom.

In a further embodiment, an assembly is provided comprising the multi-view device. The assembly is one of the following: a push button for providing a three dimensional image or a series of images on the push button, an indicator for providing an indication by means of a three dimensional image or a series of images, an advertisement sign for providing an three dimensional image or a series of images as part of the advertisement sign, a company logo presentation board for generating a three dimensional company logo presentation or for generating a series of images comprising the company logo, or a light source for generating light and presenting a three dimensional image or a series of images in the light source. The assembly according to the embodiment better attracts the attention of a viewer.

These and other aspects of the invention are apparent from and will be elucidated with reference to the embodiments described hereinafter.

### BRIEF DESCRIPTION OF THE DRAWINGS

In the drawings:

FIG. 1 schematically shows an embodiment of the multi-view device,

FIG. 2 schematically shows a cross-sectional view of the multi-view device of FIG. 1 along line A-A′,

FIG. 3 schematically shows a cross-sectional view another embodiment of the multi-view device,

FIG. 4a schematically shows another cross-sectional view of an embodiment of the multi-view device,

FIG. 4b schematically shows another cross-sectional view of another embodiment of the multi-view device,

FIG. 5a schematically shows a DVD player comprising a plurality of multi-view devices,

FIG. 5b schematically shows an illumination device comprising a multi-view device, and

FIG. 5c schematically shows an advertisement sign comprising a multi-view device.

It should be noted that items which have the same reference numbers in different figures, have the same structural features and the same functions, or are the same signals. Where the function and/or structure of such an item have been explained, there is no necessity for repeated explanation thereof in the detailed description.

### DETAILED DESCRIPTION

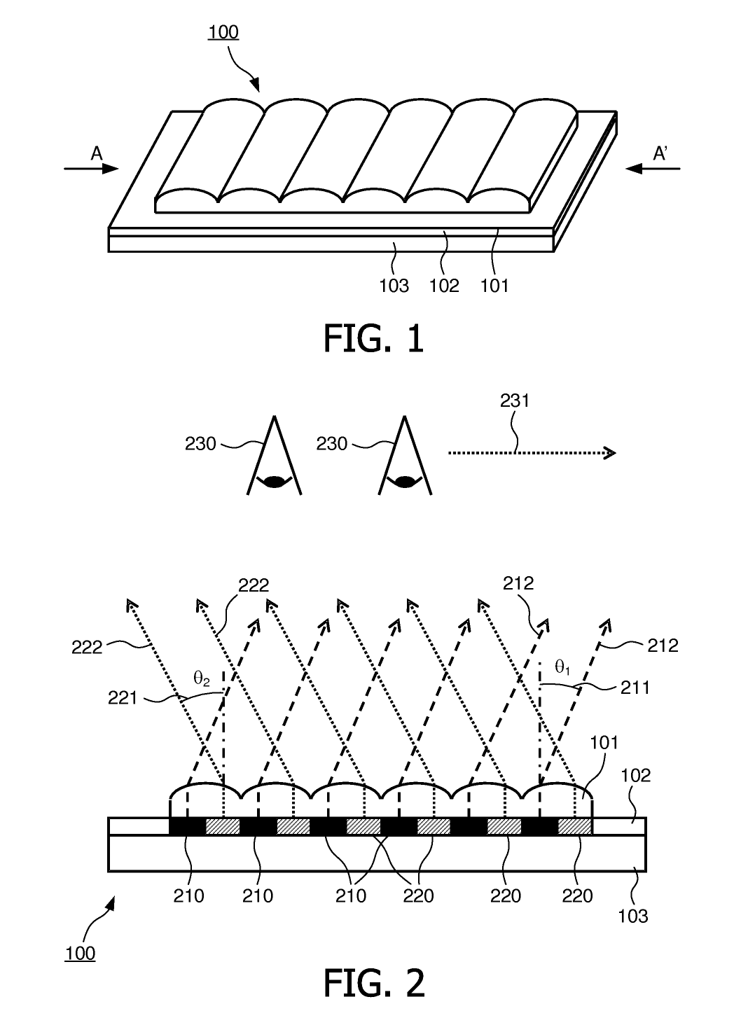

A first embodiment is shown in FIG. 1. A multi-view device 100 is shown. The multi-view device 100 comprises an array of elongated optical structures 101, a partially translucent sheet 102 that comprises at least a part of a composite image, and an Organic Light Emitting Diode device 103. The Organic Light Emitting Diode device 103 is optically coupled to the partially translucent sheet 102. The partially translucent sheet 102 is optically coupled to the array of optical structures 101. The differences between the refractive indexes of the array of optical structures 101, the translucent sheet 102 and the layers of the Organic Light Emitting Diode device 103 are small, for example smaller than 0.1. The optically coupled layers are brought in contact with each other by means of refractive index matching glue or refractive index matching oil. It results in an Organic Light Emitting Diode device 103 that is optically coupled to the array of elongated optical structures 101 and light from the Organic Light Emitting Diode device 103 may travel freely to the array of elongated optical structures 101. As shown in the figure, in this embodiment the array of elongated optical structures 101 is an array of lenticular lenses 101. The composite image comprises elongated stripes of sub images. The sub images comprise a first image and a second image.

The light of the Organic Light Emitting Diode device 103 illuminates the partially translucent sheet 102. Because at least a part of the composite image is provided on the partially translucent sheet 102, the partially translucent sheet 102 may change locally the characteristics of the light received from the Organic Light Emitting Diode device 103. At some positions on the partially translucent sheet 102 the light may be blocked or partially absorbed and at other positions the light may travel freely in the direction of the array of lenticular lenses 101. The array of lenticular lenses 101 refracts the received light such that light from the first image is refracted into a first viewing angle and such that light from the second image is refracted into a second viewing angle.

It should be noted that the Organic Light Emitting Diode device 103 device may be constituted by a single one pixel Organic Light Emitting Diode, which means that the Organic Light Emitting Diode device 103 comprises only one Organic Light Emitting Diode manufactured as an uninterrupted stack of layers forming the Organic Light Emitting Diode.

FIG. 2 shows a cross-sectional view of the multi-view device 100 of FIG. 1 at the position of line AA'. The partially translucent sheet 102 comprises at least a part of the composite image. The composite image comprises elongated stripes of sub images. The black rectangles 210 shown in the layer of the partially translucent sheet 102 are the cross-sectional views of the elongated stripes of sub images of the first image. The hatched rectangles 220 are the cross-sectional views of the elongated stripes of sub images of the second image. The elongated stripes of the first image 210 alternate with the elongated stripes of the second image 220. One elongated stripe of the first image 210 and one adjacent elongated stripe of the second image 220 are arranged together with a single lenticular lens of the array of lenticular lenses 101 such that a substantial amount of light from the one of the elongated stripe of the first image 210 and of the adjacent one of the elongated stripe of the second image 220 is received by the single lenticular lens. Light 212 of the stripes of the first image 210 is refracted by the array of lenticular lenses 101 into the first viewing angle 211 (θ₁). Light 222 of the stripes of the second image 220 is refracted by the array of lenticular lenses 101 into the second viewing angle 221 (θ₂).

If the first viewing angle 211 and the second viewing angle 221 are configured such that the eyes 230 of a user who is looking towards the multi-view device 100 both receive the light of a different image, the multi-view device functions as an auto stereoscopic device and the user experiences a three dimensional image. In another embodiment the eyes of the user 230 may move relatively to the multi-view device in a direction 231. The eyes of the user 230 may see at a first position to which the first viewing angle 211 is directed a first image and the eyes of the user 230 may see at a second position to which the second viewing angle 221 is directed a second image. While moving 231 the user 230 may experience the received images as an animation. In a specific embodiment alternating elongated stripes of a plurality of images in the translucent sheet 102 are integrated in the multi-view device 100 such that the light of the plurality of images is refracted in a plurality of viewing angles, such that the user sees an animation of a plurality of images if the user 230 moves 231 relative to the multi-view device 100.

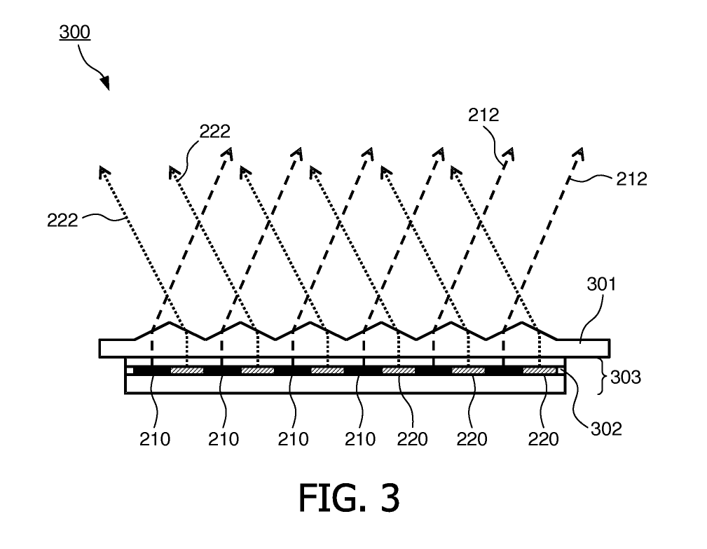

FIG. 3 shows a cross-sectional view of another embodiment of the multi-view device 300. The multi-view device 300 comprises an array of elongated optical structures 301, which is in this specific embodiment an array of triangular prisms 301. The multi-view device 300 further comprises an Organic Light Emitting Diode device 303, which is in the specific embodiment of FIG. 3 a patterned Organic Light Emitting Diode device 303. The Organic Light Emitting Diode device 303 is optically coupled to the array of triangular prisms 301.

At least a part of a composite image is patterned in a layer 302 of the patterned Organic Light Emitting Diode device 303. The part of the composite image comprises alternating sub images which are elongated stripes of a first image 210 and elongated stripes of a second image 220. The array of triangular prisms 301 is constituted such that light 212 from the stripes of the first image 210 is refracted into a first viewing angle, and light 222 from the stripes of the second image 220 is refracted into a second viewing angle.

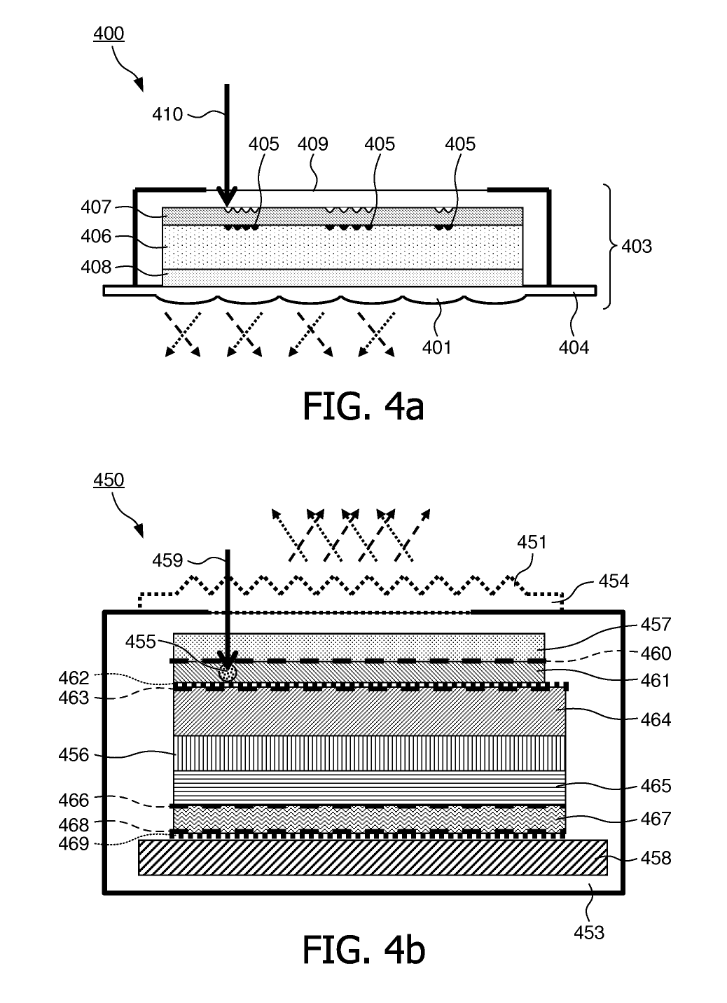

FIG. 4a shows a cross-sectional view of an embodiment of a multi view device 400 comprising a patterned Organic Light Emitting Diode device 403. The patterned Organic Light Emitting Diode device 403 comprises a substrate 404 on which the Organic Light Emitting Diode is manufactured. The substrate 404 comprises an array of lenticular lenses 401. The substrate 404 may be glass or a partially transparent sheet manufactured of, for example, a synthetic material. If the substrate 404 is of glass, the array of lenticular lenses 401 may be manufactured in the substrate 404 by etching. If the substrate 404 is a partially transparent sheet manufactured, for example, of a synthetic material, the array of lenticular lenses 401 may, for example, be manufactured by imprint technology. The Organic Light Emitting Diode is manufactured on the substrate 404 and as such there is an optimal optical coupling between the Organic Light Emitting Diode and the array of lenticular lenses 401.

The Organic Light Emitting Diode 403 generally comprises a plurality of layers 406, 407, 408 and comprises a layer 406 comprising light emitting material and comprises an anode layer 408 and a cathode layer 407 between which layer 406 is sandwiched. FIG. 4a schematically shows one layer between the anode layer 408 and the cathode layer 407, however this light emitting layer 406 comprises a layer with organic light emitting material and a plurality of current support layers (not shown) which are used to enable and/or assist and/or dimension the current flowing, in operation, through the light emitting material to cause the light emitting material to emit light. The anode layer 408 may, for example, constitute of ITO being a metaloxide being transparent for a specific range of light, allowing the light generated in the light emitting material 406 to be emitted to the ambient of the Organic Light Emitting Diode device 400. The cathode layer 407 may, for example, constitute a two nanometers Barium layer and a one hundred nanometers Aluminum layer which has good conductive characteristics and which may be well applied in semiconductor manufacturing processes. The cathode layer 407 constitutes a light reflective layer 407.

The Organic Light Emitting Diode device 403 comprises a pattern 405, which is permanently visible both in the on-state of the Organic Light Emitting Diode device as in the off-state. The pattern 405 is constituted by deformations of the aluminum of the cathode layer 407. During the on-state of the Organic Light Emitting Diode device 400 a current runs through the layer 406 with the organic light emitting material which emits light substantially in all directions. The light which is generated in the organic light emitting material of layer 406 and which progresses towards the at least partially transparent anode layer 408 is at least partially transmitted through the anode layer 408 and through the substrate 404 and subsequently emitted into the ambient of the multi-view device 400. Part of the light, which progresses towards the cathode layer 407, is reflected by the aluminum of the cathode layer 407 towards the substrate 404, which allows the light being transmitted to the ambient of the multi-view device 400. At the positions of the deformations of the pattern 405 in the cathode layer 407 the light is scattered which is clearly visible to the viewer. The viewer experiences the scattered light as local differences in brightness and as such the pattern forms an image seen by the user.

The patterning of the Organic Light Emitting Device may be performed as shown in FIG. 4a. The Organic Light Emitting Diode device 403 has at one side of the Organic Light Emitting Diode device, being the side opposite to the substrate, a patterning window 409 which allows a condensed light beams 410 to travel freely to the backside of the anode layer 408. The condensed light beam 410 provides enough power to deform the cathode layer 407 locally. The amount of power provided by the condensed light beam 410 determines the height of the deformations. The height of the deformations determines the scattering and as such the visual effect experienced by the user.

FIG. 4b shows a cross-sectional view of another embodiment of a multi-view device 450 comprising a patterned Organic Light Emitting Diode device 453. The multi-view device as shown in FIG. 4b further comprises an optical sheet 454 comprising the array of elongated optical structures 451. In the specific embodiment the array of elongated optical structures is an array of triangular prisms 451. The optical sheet is for example glued to the patterned Organic Light Emitting Diode device 453 by means of a refractive index matching glue to obtain an optical coupling between the patterned Organic Light Emitting Diode device 453 and the array of triangular prisms 451.

The patterned Organic Light Emitting Diode device 453 comprises a plurality of layers 456 . . . 469. A stack of layers 456, 460 . . . 469 is sandwiched between the anode layer 458 and the cathode layer 457. Organic Light Emitting Diode device 453 is a top-emission device which emits the light into the ambient trough a cathode which is at least partially transparent, for example through a layer of silver being 15 nm thick. The stack of layers 456, 460 . . . 469 comprises a layer of an organic light emitting material 456 which is embedded in an organic host material. This organic light emitting material 456 is configured to emit light when a current runs through the layer of organic light emitting material 456. The patterned Organic Light Emitting Diode device 453 may comprise a plurality of layers of light emitting material 456 each emitting, for example, a different color. Alternatively, the light emitting layer 456 may comprise a mix of light emitting materials which emit different colors and which together emit, for example, white light of a predefined color temperature. The patterned Organic Light Emitting Diode device 453 further comprises one or a plurality of current support layers 460 . . . 469 which are used to enable and/or assist and/or dimension the current flowing, in operation, through the light emitting material 456 to cause the light emitting material 456 to emit light. In the patterned Organic Light Emitting Diode device 453 of the multi-view device 450 of FIG. 4b the pattern is generated in at least one of the current support layers 460 . . . 469 while substantially not altering the anode 458, cathode 457 or the layer of the light emitting material 456. With the term current support layer 460 . . . 469 a layer which influences the flowing of current through the light emitting material 456 is meant with the exception of the anode layer 458, the cathode layer 457 and the light emitting material 456. Examples of the current support layer 460 . . . 469 are: a current blocking layer 469, an interface layer of the current blocking layer (not shown), a hole blocking layer 464 and an electron blocking layer (not shown), an electron injection layer 461, an interface of the electron injection layer 463, a injection inhibition layer 462, an interface layer of the injection inhibition layer (not shown), a hole injection layer 467, an interface of the hole injection layer 466, an interface layer of the cathode layer 460 and an interface layer of the anode layer 468. Local alterations 455 of the characteristic of one of these listed current support layers 460 . . . 469 will locally alter the current which flows in operation through the organic light emitting material 456 and thus locally altering the light emission characteristic. When the patterned Organic Light Emitting device 453 is switched on, these altered emission characteristics 455 are clearly visible and may be applied in a required pattern, which is clearly visible when the patterned Organic Light Emitting device 453 is switched on. Because the organic light emitting material 456, the anode layer 458 or the cathode layer 457 are not influenced, the pattern is substantially invisible, even when the patterned Organic Light Emitting device 453 is irradiated with, for example, ultraviolet light.

The local alterations 455 of one of the current support layers 460 . . . 469 may be manufactured by means of impinging a condensed light beam 459 into the Organic Light Emitting Diode 453, as shown in FIG. 4b. The condensed light beam is focused in one of the current support layers 460 . . . 469 and provides locally an amount of energy to change locally the current support characteristic of the one of the current support layers 460 . . . 469. The patterning may be performed before the optical sheet 454, comprising the array of triangular prisms 451, and the Organic Light Emitting Diode 453 are assembled together in order to prevent refraction of the condensed light beam 459 by the array of triangular prisms 451. However, the impinging condensed light beam 459 may be corrected a priori for the expected refraction by the triangular prisms 451.

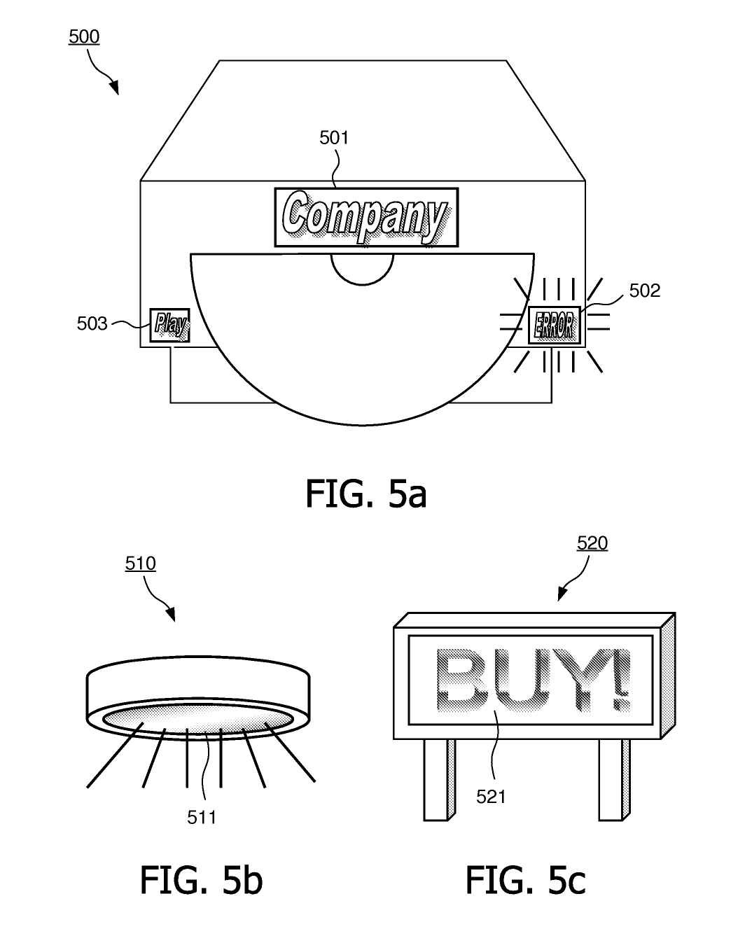

FIG. 5a schematically shows a DVD player 500 which comprises a plurality of multi-view devices 501, 502, 503 according to the invention.

A company logo 501 is presented by means of a first multi-view device 501 to the user of the DVD player 500. The company logo 501 may be visible as a three dimensional image or an animation. It is advantageous to use a patterned Organic Light Emitting Diode device with a patterned light reflective layer in the first multi-view device 501 because the company logo will be visible in the on-state as well as the off-state of the patterned Organic Light Emitting Diode device.

A second multi-view device 502 is an error-indicator 502 for providing to the user an indication that an error occurred in the operation of the DVD player 500. By switching the Organic Light Emitting Diode device alternatingly on and off a blinking error indication may be created. The use of a patterned Organic Light Emitting Diode device comprising a patterned current support layer may be advantageously in the error indicator 502, because the error indication image is not visible in the off-state of the patterned Organic Light Emitting Diode device and is only visible in the on-state. Thus, the use of a patterned Organic Light Emitting Diode device comprising a patterned current support layer enables the selective visibility of the error indication.

A third multi-view device 503 is a ‘play’ push button 503 to indicate in a three dimensional image that the ‘play’ push button 503 may be pushed to start the playing of a DVD.

FIG. 5b schematically shows an illumination device 510 comprising a multi-view device 511. The illumination device 510 may be enhanced with a three dimensional image presented by the multi-view device 511. The image imaged by the multi-view device 511 may suggest an illumination device 510 with a spherical light emitting surface.

FIG. 5c schematically shows an advertisement sign 520 comprising a multi-view device 521. The multi-view device 521 presents to the viewer a three dimensional advertisement or an animated advertisement to the viewer who, for example, passes in a car. The advertisement sign 520 attracts the attention of the user much faster than an advertisement sign which presents a two dimensional image only.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A multi-view device for generating a first image at a first viewing angle and for generating a second image at a second viewing angle different from the first viewing angle, the multi-view device comprises:
a composite image comprising elongated stripes of sub images comprising the first image and the second image,
an array of elongated optical structures for refracting light of the first image into the first viewing angle, and for refracting light of the second image into the second viewing angle,
an Organic Light Emitting Diode device for imaging the composite image via the array of elongated optical structures, the Organic Light Emitting Diode device being optically coupled to the array of elongated optical structures.

2. The multi-view device according to claim 1, wherein the Organic Light Emitting Diode device comprises a pattern constituting a patterned Organic Light Emitting Diode device, the pattern of the patterned Organic Light Emitting Diode device forming at least a part of the composite image.

3. The multi-view device according to claim 2, wherein a current support layer of the patterned Organic Light Emitting Diode device or a light-reflective layer of the patterned Organic Light Emitting Diode device forming the at least part of the composite image.

4. The multi-view device according to claim 1, wherein the Organic Light Emitting Diode device comprises a single one-pixel Organic Light Emitting Diode.

5. The multi-view device according to claim 1, wherein the Organic Light Emitting Diode device comprising a substrate for supporting an anode layer, a cathode layer and/or organic light emitting layer of the Organic Light Emitting Diode, wherein a side of the substrate facing away from the Organic Light Emitting Diode comprises the array of elongated optical structures for refracting light the first image into a first viewing angle and for refracting light of the second image into a second viewing angle.

6. The multi-view device according to claim 1 further comprising an optical sheet, wherein the optical sheet comprises the array of elongated optical structures, the optical sheet being optically coupled to the Organic Light Emitting Diode device.

7. The multi-view device according to claim 1 further comprising an at least partially translucent film wherein at least a part of the composite image is provided on the at least partially translucent film the partially translucent film being arranged between the Organic Light Emitting Diode device and the array of elongated optical structures.

8. The multi-view device according to claim 1, wherein the array of elongated optical structures comprises lenticular lenses and/or the array of elongated optical structures comprises elongated triangular prisms.

9. The multi-view device according to claim 1, wherein the composite image together with the array of elongated optical structures are configured to generate an auto stereoscopic image to a viewer looking towards the multi-view device.

10. The multi-view device according to claim 1, wherein the composite image together with the array of elongated optical structures are configured to generate a series of image to a viewer looking towards the multi-view device and moving relative to the multi-view device.

11. (canceled)
